(19) United States
(12) Patent Application Publication
(10) Pub. No.: US 2025/0190935 A1
(43) Pub. Date: Jun. 12, 2025

(54) SYSTEMS AND METHODS FOR ENHANCED PERSONAL PROPERTY ARCHIVAL AND RETRIEVAL

(71) Applicant: State Farm Mutual Automobile Insurance Company, Bloomington, IL (US)

(72) Inventors: Aaron Williams, Congerville, IL (US); Shane Knapp, Bloomington, IL (US)

(21) Appl. No.: 18/310,981

(22) Filed: May 2, 2023

Related U.S. Application Data
(60) Provisional application No. 63/343,407, filed on May 18, 2022.
(60) Provisional application No. 63/401,955, filed on Aug. 29, 2022.

(51) Int. Cl. G06Q 10/087; G06Q 40/08

(52) U.S. Cl. CPC G06Q 10/087; G06Q 40/08

(57) ABSTRACT

A computer system for archiving into a digital environment may be provided. The computer system may include at least one processor in communication with at least one memory device. The at least one processor may be programmed to (i) receive a three-dimensional (3-D) scan of an object to be archived; (ii) generate a digital twin of the object based on the 3-D scan of the object; (iii) generate a non-fungible token (NFT) for the object; and/or (iv) store the NFT and the digital twin of the object.

### CROSS-REFERENCE TO RELATED APPLICATIONS

This application claims priority to U.S. Provisional Patent Application Ser. No. 63/401,955, filed Aug. 29, 2022, and to U.S. Provisional Patent Application Ser. No. 63/343,407, filed May 18, 2022, the entire contents and disclosure of which are hereby incorporated herein by reference in its entirety.

### FIELD OF THE INVENTION

The present disclosure relates to enhanced personal property archival and retrieval and, more particularly, to a network-based system and method for generating an index of personal property associated with a user via Non-Fungible Tokens (NFTs) to recreate an inventory of personal property, and generating a virtual reality environment that includes the personal and real property of the user.

### BACKGROUND

Consumers typically have a lot of possessions. These possessions could be common household items, such as furniture, electronics and, dinnerware, as well as vehicles, buildings, and equipment. The possessions may also be family heirlooms, art, expensive or one-of-a-kind items that would be difficult to replace if a total loss occurred (e.g., a fire at the consumer's home). This also applies to small businesses that may have hard to replace physical inventory, such as antique or rare item shops, that if lost in a fire or flood these items would be gone forever.

From an insurance perspective, underwriting and claims departments historically have had difficulty in gathering contents inventory for homes and/or businesses for the purposes of valuing and underwriting an insurance policy, understanding current possession of items, understanding previous damage before a loss, and estimating current replacement values for those unique losses.

Personal Property Inventory Forms (PPIFs) may be used (if they were previously completed by a policyholder and agent) to expedite the process of claims adjustment and property replacement. However, although insurance may provide payouts for the replacement cost of items, paid claims do not bring back irreplaceable items and there currently is no “backup” to replace or represent unique items the undergo a total loss.

In addition to creating an inventory of possessions, the ability to virtually interact with the possessions of the users may be of great interest to a user. For example, the ability to create a virtual space (e.g., a metaverse) that includes both real and personal properties that allows the user or other users to interact with the properties is needed. Conventional techniques may also be inefficient, ineffective, cumbersome, not user friendly, and/or include additional drawbacks.

### BRIEF SUMMARY

The present embodiments may relate to systems and methods for providing enhanced personal property archival and retrieval. A personal property archival system, as described herein, may include a Personal Property Archival (“PPA”) computer device that is in communication with a user computer device and a virtual reality computer device. The PPA computer device may be configured to (i) receive a three-dimensional (3-D) scan of an object to be archived, (ii) generate a digital twin of the object based on the 3-D scan of the object, (iii) generate a Non-Fungible Token (NFT) for the object, and/or (iv) store the NFT and the digital twin of the object. Further, the PPA computer device may be configured to create a graphically rich, virtual space, such as a virtual reality environment, that includes the objects—both personal and real properties—where the users can interact with the objects by at least touching, feeling, using and otherwise immersing themselves into and with the objects. The created NFTs will also allow the users to track ownership of the properties if so desired. Further, the PPA computer device may be configured to create a graphically rich, virtual space, such as a virtual reality environment, that includes the objects—both personal and real properties—where the users can interact with the objects by at least touching, feeling, using and otherwise immersing themselves into and with the objects.

In one aspect, a computer system for archiving into a digital environment may be provided. The computer system may include at least one processor (and/or associated transceiver) in communication with at least one memory device. The at least one processor may be configured or programmed to: (1) receive a three-dimensional (3-D) scan of an object to be archived; (2) generate a digital twin of the object based on the 3-D scan of the object; (3) generate a non-fungible token (NFT) for the object; and/or (4) store the NFT and the digital twin of the object. The computer system may have additional, less, or alternate functionality, including that discussed elsewhere herein.

In another aspect, a computer-based method for enhanced personal property replacement may be provided. The method may be implemented on a personal property archival (“PPA”) server that includes at least one processor (and/or associated transceiver) in communication with at least one memory device. The method may include, via the at least one processor: (1) receiving a three-dimensional (3-D) scan of an object to be archived; (2) generating a digital twin of the object based on the 3-D scan of the object; (3) generating a non-fungible token (NFT) for the object; and/or (4) storing the NFT and the digital twin of the object. The method may include additional, less, or alternate actions, including those discussed elsewhere herein.

In yet another aspect, at least one non-transitory computer-readable storage media having computer-executable instructions embodied thereon may be provided. When executed by at least one processor, the computer-executable instructions cause the processor to: (1) receive a three-dimensional (3-D) scan of an object to be archived; (2) generate a digital twin of the object based on the 3-D scan of the object; (3) generate a non-fungible token (NFT) for the object; and/or (4) store the NFT and the digital twin of the object. The computer-executable instructions may direct additional, less, or alternate functionality, including that discussed elsewhere herein.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and are instrumentalities shown, wherein:

FIG. 1 illustrates a flow chart of an exemplary process for processing and archiving a physical object into a digital environment in accordance with one embodiment of this disclosure.

FIG. 2 illustrates a simplified block diagram of an exemplary computer system for implementing the process shown in FIG. 1.

FIG. 3 illustrates a flow chart of an exemplary computer-implemented process for processing personal property replacement claims using the system shown in FIG. 2.

FIG. 4 illustrates an exemplary configuration of a client computer device shown in FIG. 2, in accordance with one embodiment of the present disclosure.

FIG. 5 illustrates an exemplary configuration of a server shown in FIG. 2, in accordance with one embodiment of the present disclosure.

FIG. 6 illustrates a diagram of a forever digital archive that may be used with the processes shown in FIGS. 1 and 3.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION OF THE DRAWINGS

The present embodiments may relate to, inter alia, systems and methods for providing enhanced personal property archival and retrieval. A personal property archival system, as described herein, may include a Personal Property Archival (“PPA”) computer device that is in communication with a user computer device and a virtual reality computer device. In an exemplary embodiment, the process is performed by Personal Property Archival (“PPA”) computer device, also known as a Personal Property Archival (“PPA”) server. In the exemplary embodiment, a user, such as a policyholder, works with an insurance provider or other entity associated with a policy to inventory and generate a three-dimensional (“3D”) archive of all of the personal property associated with or owned by the user (or policyholder) that would be covered by the insurance policy prior to any event occurring that causes a loss for the user or an insurance policyholder. Further, the PPA computer device may be configured to create a graphically rich, virtual space, such as a virtual reality environment, that includes the objects-both personal and real properties—where the users can interact with the objects by at least touching, feeling, using and otherwise immersing themselves into and with the objects.

For instance, a user may use a 3-D indexing tool to scan the objects that the policyholder wishes to protect. The 3-D indexing tool may scan and capture the physical essence of the object including, but not limited to important artifacts and one-of-a-kind items. The scan information provided by the 3-D indexing tool may be used to generate a ‘digital twin’ of the physical object.

The digital twin may be a 3-D representation of the object that may be viewed at any angle and may be interacted with in a virtual environment. In the exemplary embodiment, a Non-Fungible Token (NFT) may be generated to log the ownership of the physical object and the corresponding digital twin. In some embodiments, the digital twin may include a link to the NFT that indicates the ownership of the digital twin and/or the physical object itself.

As used herein, an NFT (Non-Fungible Token) is a digital asset that represents another object, such as, but not limited to, a real-world object and/or a digital object. The NFT may be generally stored in a blockchain or other cryptographic ledger or register. The NFT may include, but is not limited to, ownership information and a link to a digital asset file that describes, points to, or otherwise indicates the real-world or digital object. NFTs may be traded, sold, exchanged, or otherwise change ownership. The ownership change may be stored on the corresponding blockchain, ledger, and/or register.

A blockchain is a distributed database that maintains a continuously-growing list of ordered records, known as blocks. Each block may contain at least a timestamp and a link to the previous block in the chain. The link to the previous block may be a hash of the previous block. For an insurance contract, the first block may contain the initial contract between a driver and an insurer. The second block may contain a modification to the contract that was requested by the driver and approved by the insurer. The second block may contain a hashed copy of the first block as well. The third block may contain one or more additional terms for the insurance contract and a hashed copy of the second block. This continues on with each block adding on to the next while containing a hash of the previous blocks in the blockchain.

To ensure the security of the information contained in the blockchain, copies of the blockchain may be distributed across multiple computer devices, known as nodes. These nodes maintain the blockchain, update the blockchain when changes occur, and ensure the stability of the blockchain itself. In some embodiments, nodes may be also used to calculate the hash of the previous blocks. As the blockchain grows, the processing power needed to calculate the hash of the previous blocks grows as well. In these embodiments, the processing of the hash may be distributed over multiple computer devices to improve the speed of processing and/or to not overburden the hashing processor. When a node processes (hashes) a block, that node is known as a miner, where the action of validating and hashing the block is also known as mining.

The use of Virtual Reality (VR) and Augmented Reality (AR) for interacting with a 3D objects provides a new interface for using 3-D objects in new manners. VR and AR systems allow a user to interact with a 3D virtual environment in a new way compared to traditional interactions using a two-dimensional (2-D) display. In VR, a user may be immersed in a virtual environment (e.g., using a VR headset). In other words, a VR device displays images, sounds, etc. to the user in a way that mimics how a user receives sensory stimuli in the real world. In AR, the user may be provided with digital data that overlays objects or environments in the real world (such as via AR glasses). AR devices may use a camera or other input to determine the objects in a user's line of sight and present additional digital data that compliments the real-world environment. Conversely, any virtual or digital environment displayed to a user through a VR computing device may be considered a VR environment.

In addition, in some further embodiments, an AR or VR device may also directly neurally transmit the virtual or augmented reality to the user through the use of neural transmitters that may directly interact with the brain, nerves, and/or sensory organs of the user.

Examples of VR environments may include, but are not limited to, Minecraft® (Minecraft is a registered trademark of Microsoft Corporation, Redmond, Washington), Metaverse, and Second Life® (Second Life is a registered trademark of Linden Lab of San Francisco, CA). These VR environments allow the user to interact with and modify said environments using VR tools, such as by building and creating content including structures and objects.

As described in further detail herein, VR and AR technologies may be utilized to more effectively handling and using 3-D objects, such as described herein. In one embodiment, a user interacts with a 3D object using VR. Specifically, the user navigates a virtual environment, applying bounding frames to objects, labeling objects, rotating views, and traversing areas of the virtual environment using a VR device. In other words, the user is immersed in a virtual environment and interacts with the virtual environment through the VR device in order to interact with and/or view the 3D objects. In one embodiment, the virtual environment is a recreation of a house and the user places 3-D objects in the house, such as in the same relative place that those 3-D objects are placed in the real world.

In another embodiment, a user views a real-world environment, and an AR device displays virtual content overlaying the real-world environment. Specifically, if the user is in a geographic location associated with the geographic location of a 3D object, the AR device may overlay the real world environment with virtual objects from the 3D digital environment, allowing the user to interact with the digital environment and digital objects.

As used herein, “VR environment” refers to a digital or virtual environment experienced by or displayed to a user through a VR computing device. In other words, “VR environment” refers to the VR view and functionality experienced by a user through a VR enabled computing device. Conversely, any virtual or digital environment displayed to a user through a VR computing device may be considered a VR environment.

As used herein, “AR environment” refers to a digital or virtual environment overlaid on a real-world environment and experienced by a user through a VR/AR computing device. In other words, “AR environment” refers to the AR display and functionality experienced by a user through an AR enabled computing device.

In some further embodiment, the VR and/or AR may allow for haptic response to allow the user to feel an interacted with object. The haptic response may be provided through the use of gloves or other feedback devices. In one embodiment, the haptic response allows the user to feel the texture of the 3-D object and/or the weight of the 3-D object.

In the exemplary embodiment, the PPA computing device is in communication with one or more storage hubs or databanks, that are databases of digital twins and their corresponding NFTs. The PPA computing device is able to determine which digital twins are associated with an individual policyholder and/or individual policy. The PPA computing device generates an inventory of the objects associated with the policyholder or other individual.

In the case of a loss or insurance claim, the PPA computing device may then be able to determine the items lost, their corresponding value, and their replacement and/or repair costs. In the case of rare and/or unique objects, the 3-D scanned digital twin may be inspected to determine the value of the object. In some cases, the digital twin may be inspected and compared to a damaged object to determine what it would take to repair the object. In some further embodiment, the digital twin may be used to create one or more files that may be used to 3-D print or otherwise create a replacement object, and/or provide parts to repair the object.

In additional embodiments, objects may also be cataloged through reviewing the individual's purchase history from apps, bank statements, receipts, or other linked in programs or stores. Transactions related to rare or valuable items may be recorded as NFTs, assigned ownership, and may become a part of a ‘bank’ or inventory of objects in the individual's possession.

In some further embodiments, the individual's inventory may be used in a virtual reality environment. In this virtual reality environment, the individual may use the digital twins of their objects in their virtual reality surroundings. For example, an individual may recreate a virtual version of their house (or other structure) in the virtual reality. Then the individual may add the digital twins of the items that they own to the virtual house, such as, but not limited to, furniture, fixtures, pictures, and/or mementos. In this way the individual may create a complete digital twin of their house or other structure.

The virtual reality house may then be used and/or toured by others. In this example, the individual may recreate a house, such as the one that they grew up in or a specific family member's house. For instance, the individual may be a grandparent and recreate their house so that they may invite others over virtually for a virtual family meal or activity. By having the recreated virtual environs, the activity may occur in known settings.

This virtual house recreation may also be useful for sick or injured individuals so that they may virtually meet with friends and family without seeing them in a hospital bed or other convalescent state. These individuals may be able to host others in a virtual gathering and be able to move around and interact with the virtual surroundings more than they would with the physical surroundings.

The virtual house and object recreation may also be used for allowing the individual to interact with a virtual representation of their physical house to help trigger memories or relax the individual by placing them in comfortable and/or known surroundings. The virtual recreations may also be used by caregivers and/or healthcare providers to work with individuals with memory loss and/or dementia. By having a virtual recreation of the individuals surroundings in their home environment, a caregiver and/or healthcare provider may visit the recreation to look-up or identify one or more objects that the patient has mentioned. This may allow the caregiver and/or healthcare provider to create, locate, and/or recreate objects for the patient.

In some embodiments, the virtual structure recreation may be used for insurance purposes. A 3-D scan may be taken of each room of the structure to create a digital twin of the structure. Then each room may be populated with objects scanned and/or entered by the user. For example, a digital twin of a house may be populated with digital twins of the physical objects that are in the physical house. The digital twin objects may be used to create a list and/or virtual inventory of the physical objects that are in the physical house.

In the case of a loss and/or insurance event, the inventory may be consulted to determine which objects were in the house. The virtual house and virtual objects may also be inspected by underwriters and/or other individuals associated with the insurance provider to catalog each item and determine an insurance value in case of damage and/or loss. Furthermore, the virtual house and/or digital twin objects may also be inspected after a loss and/or insurance event, such as a fire. This would allow claim processors to inspect the original, insured condition of the total loss items.

In another embodiment, the virtual structure filled with digital twin objects may also be used to recreate lost or destroyed locations for museums or other historical recreations. In a further embodiment, the virtual structure filled with digital twin objects may be used to divide up possessions, such as in the case of a divorce or inheritance. The interested parties may view the digital twin objects, and mark which items that they may be interested in. The corresponding NFTs could be updated to show the changes in ownership.

The virtual structure may include, but is not limited to, homes (including current, past, future, and dream), businesses (including current, past, future, and dream), and other structures (including small structures such as sheds and/or tree houses or large structures such as monuments and museums). The structures may be recreations of structures that are no longer available, such as a house that had previously burned down or been sold. The structures may also be recreations of currently existing structures, such as the user's current home or business. The structures may also be recreations of future or dreamed for structures. These may include structures that are being built and/or remodeled, structures that have been purchased but not yet inhabited or used, or structures that are being considered for purchase. The user may populate these virtual structures with digital objects, such as the digital twins, to recreate or to see how the objects would fit in other structures.

This could also be done at a shopping retail location, such as an antique store or other store that includes unique and/or rare items. Rather than allowing individuals to handle the physical items, the individuals may view and inspect the digital twins of the items that they are interested in. This may allow each individual to visit shops in different locations without having to travel to the physical location. While many websites allow individuals to view objects for sale, those views are generally two dimensional images that may make it difficult to judge the relative size and other aspects of the object. The 3-D scans that create the digital twin would provide additional detail. Furthermore, in the case of jewelry and/or other wearable items, the individual may be able to virtually try on the object. In an additional embodiment, the potential buyer may be able rent or acquire (permanently or temporarily) the digital twin of the object and then see how the object would look in their virtual house. When an individual purchases one of the digital twins and the corresponding physical object, the NFT associated with the digital twin may be updated to show the change in ownership. The information about the digital twin and the NFT may be transmitted to an insurance provider computer device for the insurance provider to insure the object.

In one example, an individual purchases a rare clock valued at $100,000. The individual scans every detail of the clock using a 3-D indexing tool. A digital twin of the clock is generated from the scans of the clock. An NFT for the clock is generated and is linked to the digital twin. The NFT establishes the individual as the owner of the clock. The NFT and the digital twin are stored by a bank or other secure database associated with the insurance provider.

The individual requests that the insurance provider insures the clock. The NFT and the digital twin are provided to an insurance agent and/or underwriter. The agent and/or underwriter inspects the NFT and the digital twin to determine the current condition of the clock and provide an insured value. The clock is then insured.

Later, the clock become damages and needs to be repaired. A claims processor inspects the pre-damaged condition of the clock based on the digital twin. The claims processor may compare the digital twin to the damaged version of the clock. The claims processor may then determine a repair (or replacement) value.

If the clock experiences a total loss, the claims processor may inspect the original condition of the clock to try to match an exact replacement or provide a payout for the loss.

After the payout, the NFT is altered to indicate the destroyed status of the original clock. However, the individual may continue to display the digital twin in a virtual house or other virtual environment.

At some point, a hacker may gain access to the individual's digital environment and damages their digital twin. The individual may recreate the digital twin from the bank or database of the insurance provider (or other entity).

In some embodiment, the insurance provider insures a purely digital asset. If the digital asset is destroyed or corrupted, such as by a hacker, the insurance provider may provide a replacement digital asset and/or a payout for the lost digital asset.

In another example, an individual has a lot of objects of family history in the form of documentation and physical artifacts. Every document, picture, and heirloom may be scanned by a 3-D indexing tool. Digital twins of all of the objects may be created. NFTs may be created for each object as well, indicating the corresponding digital twins and ownership. The NFTs and/or the digital twins may be uploaded into a database or other digital bank. The individual may view the digital twin of each object whenever they want.

In this example, the individual's house is destroyed, and all of the family heirlooms and documents are destroyed. The NFTs are still stored in the database and/or digital bank. The individual may continue to view the digital versions of the heirlooms. The individual may determine whether or not to duplicate the heirlooms, documents, and/or pictures, such a through 3-D printing or other manufacturing. The individual may either interact with the virtual versions and/or the recreated physical versions.

In additional embodiments, the inventory may be supplemented with additional information, such as information from one or more smart home devices in the policyholder's residence. In this embodiment, the PPA server may determine which components where connected to the smart home system, such as, but not limited to, smart locks, furnaces, air conditioners, thermostats, light bulbs, televisions, appliances, sensors, and any other device or processor, run through the smart home device, such as through a smart home hub.

In another embodiment, the PPA server may receive information about the devices connected to the Wi-Fi network at the user's or policyholder's residence. In this example, the PPA server may receive message traffic data, log data, or other data that allows the PPA server to identify the devices that connected to the policyholder's network. These devices may include mobile devices, laptops, desktops, tablets, smartphones, IP cameras, smart refrigerators, smart stoves, and other wireless connected devices. The PPA server may be able to determine a make and model associated with each electronic device that connected to the network, such as by PINs, or identification or manufacturer numbers.

In another example, the PPA server receives data from computer devices associated with one or more retailers to determine household goods that the policyholder has purchased. The PPA server may use the data to determine the purchases made by the policyholder over various periods of time. This data may include makes, models, and quantities of household goods purchased by the policyholder.

In yet another example, the policyholder may take video or pictures of his house and possessions to show what he currently owns and is keeping in the house, and transmit that video to the PPA server to assist in generating the index. The PPA server may then, for example, run pattern recognition, object recognition, optical character recognition, or other machine learning techniques to identify goods, and current quality, quantify, or status of the goods. The PPA server may also use the video and/or pictures to determine where in the house different objects are and associate the digital twins with that location in a virtual house for the individual.

The policyholder may also prepare lists of his/her possessions, such as either manually and/or by using his or her mobile device and image analysis. These possessions may include household goods associated with, or owned by, the policyholder. The PPA server may use any of these above methods to determine additional objects that are associated with or owned by the individual/policyholder. For example, the individual/policy holder may indicate that they own a particular model of gaming console. Rather than having the individual/policy holder 3-D scan the gaming console, the PPA server may access a previous scan/digital twin of the model of gaming console and create a copy of the digital twin of that gaming console for the individual/policyholder. The PPA server may then create an NFT for the gaming console indicating that the individual/policyholder is the owner of that model of gaming console.

These lists and inventories may be extremely valuable before a loss occurs, as it may be hard for the policyholder to remember everything after the fact. In addition, performing this inventory prior to a loss may help to prevent the policyholder from listing items as lost that the policyholder didn't own. These inventory listings of 3-D objects are also important for determining the replacement value and the depreciated value of the reported lost items, and/or facilitate more accurate risk assessment and claim handling.

In addition, the user or policyholder may determine their replacement preferences in the case of a loss occurring. The user or policyholder may list his/her replacement preferences for when a loss occurs, which are stored by the PPA server and/or their mobile device. For example, the user or policyholder may determine that he would want to replace a lost dining room set with the exact same set, if the original set was lost or damaged, for example in a fire. The user or policyholder may also decide that he would want to replace his plates with the exact set that he had before the loss event. The user or policyholder may further determine to recreate a lost artifact or other unique object using the 3-D scan of the object associated with the NFT.

At some point an event occurs that causes a loss for the policyholder or other user. This event could be any event that results in a loss for the policyholder that causes the policyholder to submit a claim. For example, the event may be a fire or storm damage to the policyholder's house. This event may cause the policyholder to lose his residence and have to move to another address, either permanently or temporarily.

In another example, the loss could be a partial loss. For example, either where the policyholder's home is only partially damaged, or where the policyholder's vehicle was broken into, and several items were taken out of the vehicle.

When a claim is initially processed, the PPA server may create a claim fund based upon the policy and the items lost. The PPA server may adjust the claim fund based upon the items lost, the availability of direct replacements, the replacement costs for items lost, and/or the depreciation associated with the lost items.

The systems and methods described herein provide for supporting insurance, recovery, and cyber-protection of real-world, digital twin, and native digital assets. The systems and methods described herein may also provide for methods for making underwriting and claims processing be more efficient through the use of 3-D indexing valuable and unique items so that they may be inspected to provide with an insurance value, cataloged and replaced after a total loss event.

The systems and methods described herein may further provide for claims processors to inspect the original, insured condition of total loss items. In addition, the systems and methods described herein may provide methodologies to insure digital assets and assign ownership and possession of items using NFTs for insurance purposes. Moreover, the systems and methods described herein may provide methodologies to catalog and assign ownership of items purchased online or through a virtual reality environment, such as avatars, buildings, and/or skins, for example, and to store these digital objects in a secure environment, such as a secure digital bank. Furthermore, the systems and methods described herein may provide methodologies to track physical and digital possession and transfer of ownership via NFTs. Finally, the systems and methods described herein may provide methodologies to create exact match replacements of rare, one-of-a-kind items through 3-D indexing scans and 3-D printing.

At least one of the technical problems addressed by this system may include: (i) improving speed and efficiency of replacing items covered by an insurance claim; (ii) improving accuracy and reducing fraud (or buildup) on determining items owned by a policyholder prior to a loss event; (iii) saving time for policyholder in replacing lost items; (iv) saving accurate records and scans to allow recreation of damaged items; (v) allowing the user to interact with 3-D representations of destroyed objections; (vi) allowing multiple users to view and interact with 3-D representations of objects; (vii) saving time for policyholder in purchasing household essentials after a loss event; and/or (viii) streamlining the item replacement process to faster process claims.

The methods and systems described herein may be implemented (i) using computer programming or engineering techniques including computer software, firmware, hardware, or any combination or subset thereof, and/or (ii) by using one or more local or remote processors, transceivers, servers, sensors, servers, scanners, AR or VR headsets or glasses, smart glasses, and/or other electrical or electronic components, wherein the technical effects may be achieved by performing at least one of the following steps: (a) receive a three-dimensional (3-D) scan of an object to be archived; (b) generate a digital twin of the object based on the 3-D scan of the object; (c) generate a non-fungible token (NFT) for the object; and/or (d) store the NFT and the digital twin of the object.

### Exemplary Process for Processing Personal Property Replacement Claims

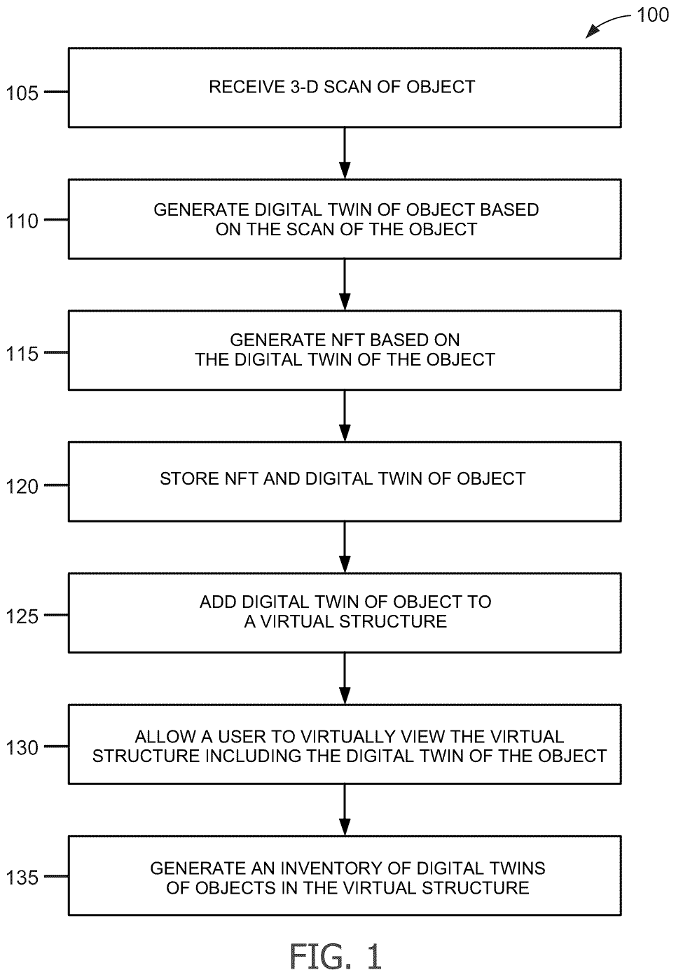

FIG. 1 illustrates a flow chart of an exemplary process 100 for processing and archiving a physical object into a digital environment in accordance with one embodiment of this disclosure. Examples of physical objects may include, but are not limited to, household goods, furniture, electronics, kitchen utensils, antiques, documents, artifacts, keepsakes, photographs, appliances, and any other physical objects that the user would like to save in a digital environment. For the purposes of this discussion, the digital environment may include, but is not limited to, a database, a databank, a storage device, a VR environment, an AR environment, a XR (extended Reality) environment, and/or any other methodology of storing and accessing digital information.

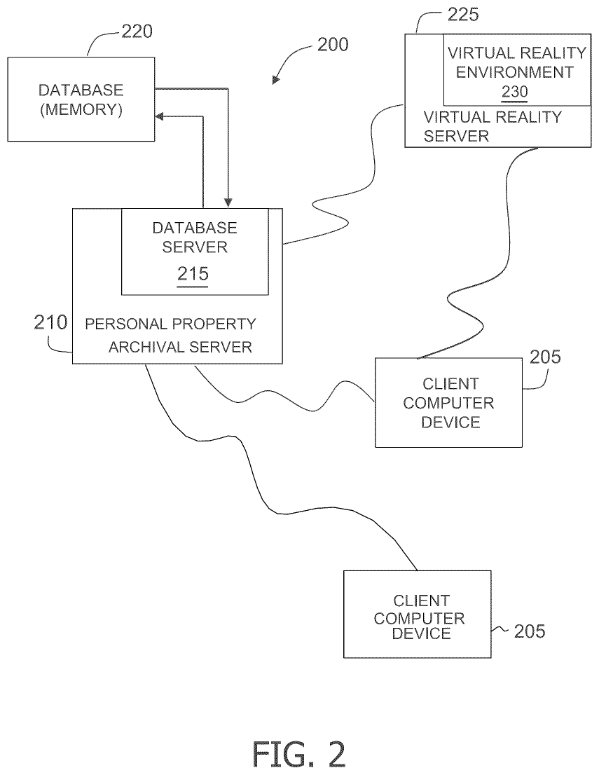

In the exemplary embodiment, process 100 may be performed by a Personal Property Archival (“PPA”) computer device, also known as a Personal Property Archival (“PPA”) server 210 (shown in FIG. 2). In one embodiment, an individual, such as a policyholder or other user, has decided to generate and store a digital twin copy of a physical object. The individual may be generating and storing the digital twin for inventory or other protection purposes.

The PPA server 210 may receive 105 a 3-D scan of a physical object. The physical object may include, but are not limited to, household goods, furniture, electronics, kitchen utensils, antiques, documents, artifacts, keepsakes, photographs, appliances, and any other physical objects that the user would like to save in a digital environment. The 3-D scan may be created by a 3-D indexer, a 3-D camera, a plurality of 2-D images, and/or any other tools that would create a 3-D scan that may be used as described herein.

The PPA server 210 may generate 110 a digital twin of the physical object based on the scan of the object. The digital twin is a complete digital representation of the physical object based on the 3-D scan. The digital twin matches the colors, shapes, textures, and other features of the physical object. If the physical object may change, such as by being opened, then the digital twin is generated to simulate that functionality.

In a first example, the physical object may be a wardrobe filled with clothes. The digital twin would then be generated to have doors that open. In another example, the physical object is a clock that has a bird pop out every hour, then the digital twin will be generated with that feature. The digital twin allows a user to see, inspect use, open, and potentially feel the digital version of the object.

The PPA server 210 may generate 115 an NFT (non-fungible token) based on the digital twin of the physical object. The NFT may include information identifying the digital twin, the original object, and the ownership of both items. If the ownership of the physical object changes, such as by being sold or destroyed, then the NFT may be updated with that information.

The PPA server 210 may store 120 the NFT and the digital twin of the physical object. In the exemplary embodiment, the NFT may be stored on a blockchain, while the digital twin may be stored in a database, such as database 220 (shown in FIG. 2). The NFT may include a pointer to where the digital twin is currently stored. The NFT's pointers may be updated when the location of the digital twin is changed.

The PPA server 210 may add 125 the digital twin of the physical object to a virtual structure. In the exemplary embodiment, the PPA server 210 may be in communication with a virtual reality server 225 that is hosting one or more virtual reality environments 230 (both shown in FIG. 2). In some embodiments, the digital twin may be added 125 to the virtual structure by the PPA server 210. In these embodiments, the PPA server 210 may know where the physical object is stored, and place the digital twin in a similar location in a virtual structure, such as a virtual copy of the user's house. In other embodiments, the user may add the digital twin to a structure, such as one in the virtual reality environment 230. In some of these embodiments, the virtual reality environment 230 may be a recreation of a house or business and the digital twin is an object from that house or business.

The PPA server 210 (or the virtual reality server 225) may allow 130 a user to virtually view the virtual structure including the digital twin of the physical object. In the exemplary embodiment, the VR environment may allow the user to travel through and interact with the virtual structure and/or one or more digital objects in the virtual structure, where the virtual objects may include one or more digital twins of physical objects. The virtual structure may also include digital objects, that are purely digital. Such as a virtual lamp or wallpaper that the user purchased to display in the virtual structure.

In the exemplary embodiment, the PPA server 210 may generate 135 an inventory of the digital objects in the virtual structure including digital twins and purchased (or otherwise acquired) digital objects. This inventory may be used for insurance tracking, collection tracking, store inventory tracking, and/or any other purpose.

In one proposed instance, the policyholder and/or an insurance agent may walk about a home with a 3-D scanner or 3-D indexing device, and acquire 3-D scans of the objects in the home. Additionally or alternatively, the 3-D scan data may be transmitted via wireless communication or data transmission over one or more radio frequency links to a remote server, and the remote server may analyze the scan data to identify objects, such as using objection recognition or machine learning techniques. A virtual list of household and other goods may then be generated by the PPA server 210. Based upon this list, an index may be generated by the PPA server 210.

Additionally, the PPA server 210 may determine which components where connected to the smart home system, such as, but not limited to, smart locks, furnaces, air conditioners, thermostats, light bulbs, appliances, sensors, and any other device or processor run through the smart home device, such as through a smart home hub. Furthermore, the PPA server 210 may receive information about the devices connected to the Wi-Fi network at the policyholder's residence. The PPA server 210 may receive message traffic data, log data, or other data that allows PPA server 210 to identify the devices that connected to the policyholder's network. These devices may include laptops, desktops, tablets, smartphones, IP cameras, smart refrigerators, smart stoves, and other wireless connected devices or mobile devices. The PPA server 210 may be able to determine a make and model associated with each electronic device that is connected to the network.

In another example, PPA server 210 may receive data from computer devices associated with one or more retailers to determine household goods that the policyholder has historically purchased either through the one or more retailers' online presences or through their actual physical locations (i.e., brick and mortar stores). Furthermore, the PPA server 210 may use this information about devices in the home to generate digital twins and NFTs for each detected item.

The policyholder may also prepare lists of his/her possessions, such as either manually or by using his or her mobile device and image analysis. These possessions may include household goods owned by the policyholder. The PPA server may use any of these above methods to determine additional objects that are associated with, or owned by, the individual/policyholder. For example, the individual/policy holder may indicate that they own a particular model of gaming console. Rather than having the individual/policy holder 3-D scan the gaming console, the PPA server may access a previous scan/digital twin of the model of gaming console and create a copy of the digital twin of that gaming console for the individual/policyholder. The PPA server may then create an NFT for the gaming console indicating that the individual/policyholder is the owner of that model of gaming console.

These lists and inventories may be extremely valuable before a loss occurs, as it may be hard for the policyholder (or other user) to remember everything after the fact. In addition, performing this inventory prior to a loss helps to prevent the policyholder from listing items as lost that the policyholder didn't own. These inventory listings of 3-D objects are also important for determining the replacement value and the depreciated value of the reported lost items, and/or facilitate more accurate risk assessment and claim handling.

In addition, the policyholder (or other user) may determine their replacement preferences in the case of a loss occurring. The policyholder may list his/her replacement preferences for when a loss occurs, which are stored by the PPA server 210 and/or their mobile devoice. For example, the policyholder may determine that he would want to replace a lost dining room set with the exact same set, if the original set was lost or damaged, for example in a fire. The policyholder may also decide that he would want to replace his plates with the exact set that he had before the loss event. The policyholder may further determine to recreate a lost artifact or other unique object using the 3-D scan of the object associated with the NFT.

At some point an event occurs that causes a loss for the policyholder. This event could be any event that results in a loss for the policyholder that causes the policyholder to submit a claim. For example, the event may be a fire or storm damage to the policyholder's house. This event may cause the policyholder to lose his residence and have to move to another address, either permanently or temporarily. In another example, the loss could be a partial loss. For example, either where the policyholder's home is only partially damaged, or where the policyholder's vehicle was broken into, and several items were taken out of the vehicle.

When a claim is initially processed, the PPA server 210 may create a claim fund based upon the policy and the items lost. The PPA server 210 may adjust the claim fund based upon the items lost, the availability of direct replacements, the replacement costs for items lost, and/or the depreciation associated with the lost items.

Further, the PPA server 210 may be configured to create a graphically rich, virtual space, such as a virtual reality environment, that includes the objects—both personal and real properties—where the users can interact with the objects by at least touching, feeling, using and otherwise immersing themselves into and with the objects. As described herein, the PPA server 210 includes the include the ability to scan a real-world environment and then reproduce that environment in the virtual reality environment 230. In one example, a user scans their outdoor garden with a tool, such as a 3-D scanner and/or indexer. The user then imports that scan into an NFT. That NFT can then be stored in a blockchain and accessed within the virtual reality environment 230. Within the virtual reality environment 230, the user can engage with the digital twin of the real-world garden that they scanned.

### Exemplary Computer Network

FIG. 2 depicts a simplified block diagram of an exemplary computer system 200 for implementing process 100 shown in FIG. 1. In the exemplary embodiment, system 200 may be used for archiving and viewing digital objects, such as digital twins. As described below in more detail, a Personal Property Archival (“PPA”) server 210 may be configured to receive a three-dimensional (3-D) scan of an object to be archived, generate a digital twin of the object based on the 3-D scan of the object, generate a Non-Fungible Token (NFT) for the object, and/or store the NFT and the digital twin of the object.

In the exemplary embodiment, client computer devices 205 are computers that include a web browser or a software application, which enables client computer devices 205 to access PPA server 210 using the Internet. More specifically, client computer devices 205 are communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem.

Client computer devices 205 may be any device capable of accessing the Internet including, but not limited to, a mobile device, a desktop computer, a laptop computer, a personal digital assistant (PDA), a cellular phone, a smartphone, a tablet, a phablet, wearable electronics, smart watch, virtual headsets or glasses (e.g., AR (augmented reality), VR (virtual reality), or XR (extended reality) headsets or glasses), chat bots, or other web-based connectable equipment or mobile devices. In some embodiments, client computer devices 205 are capable of accessing virtual environments 230, such as through virtual reality servers 225. Conversely, any virtual or digital environment displayed to a user through a VR computing device may be considered a VR environment.

In addition, in some further embodiments, an AR or VR device may also directly neurally transmit the virtual or augmented reality to the user through the use of neural transmitters that may directly interact with the brain, nerves, and/or sensory organs of the user.

A database server 215 may be communicatively coupled to a database 220 that stores data. In one embodiment, database 220 may include scan files, digital twins, NFTs, ownership information, virtual reality environments 230, claims received from the policyholder, and/or preferences provided by the policyholder. In the exemplary embodiment, database 220 may be stored remotely from PPA server 210 and/or virtual reality server 225. In some embodiments, database 220 may be decentralized. In the exemplary embodiment, a person may access database 220 via client computer devices 205 by logging onto PPA server 210 and/or virtual reality server 225, as described herein.

PPA server 210 may be communicatively coupled with one or more the client computer devices 205. In some embodiments, PPA server 210 may be associated with, or is part of a computer network associated with an insurance provider, or in communication with the insurance provider's computer network (not shown). In other embodiments, PPA server 210 may be associated with a third party and is merely in communication with the insurance provider's computer network. In some of these embodiments, the PPA server 210 is associated with a virtual reality server 225.

One or more virtual reality servers 225 may be communicatively coupled with PPA server 210. The one or more virtual reality servers 225 each may be associated with a virtual reality environment 230. Virtual reality servers 225 may provide tools and/or applications for users to access their associated virtual reality environments 230 over the Internet. For the purposes of this discussion, virtual reality environments 230 provide immersive environments that simulates how a user receives stimuli in the real world. In some embodiments, this virtual reality environment 230 can be created by scanning real-world objects and places. Furthermore, the virtual reality environment 230 can include a plurality of digital twin objects, such as those stored in NFTs.

In one example, virtual reality goggles allow a user to see a virtual world. The VR goggles determine when the user turns their head and then renders imaging of what is where the user is looking. Furthermore, the user may use input tools, such as controllers to interact with the environment displayed by the goggles. A user may then interact with digital objects, such as digital twins that have been added to the virtual reality environment 230.

In some embodiments, virtual reality environments 230 simulate parts or portions of the real-world and allow users to own and alter locations in the virtual reality environments 230. For example, a user may own a plot of virtual land and build a version of their real-world house on that plot of land. The user may then add digital twins of the objects in their real-world house to the virtual house. Other users may then interact with the digital house and the contained digital twin objects. For example, a user could recreate their grandmother's house and invite family members over to the virtual recreation for a party or other activity. Additionally or alternatively, the user may be a family member or spouse of an insured, property owner, or policyholder.

### Exemplary Computer-Implemented Method for Processing Personal Property Replacement Claims

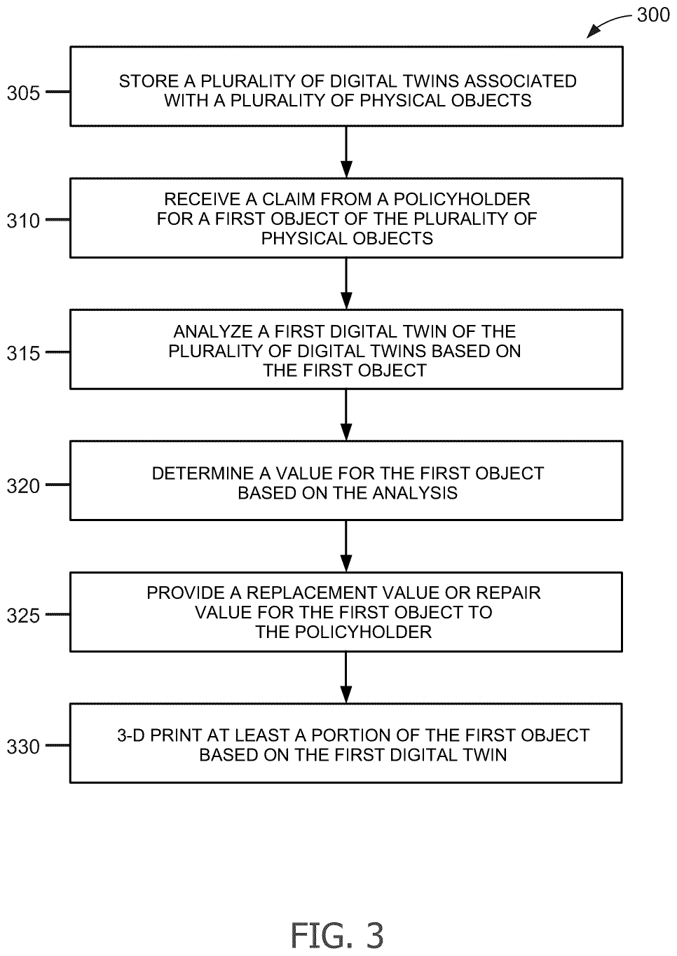

FIG. 3 depicts a flow chart of an exemplary computer implemented process 300 for processing personal property replacement claims using the system 200 (shown in FIG. 2). Process 300 may be implemented by a computing device, for example PPA server 210 (shown in FIG. 2). In the exemplary embodiment, PPA server 210 may be in communication with one or more virtual reality servers 225 and one or more client computer devices 210 (both shown in FIG. 2).

At some point an event may occur that causes a loss for the policyholder (or other user). This event may be any event that results in a loss for the policyholder that causes the policyholder to submit a claim. For example, the event may be a fire or storm damage to the policyholder's house. This event may cause the policyholder to lose his/her residence and have to move to another address, either permanently or temporarily. In another example, the loss could be a partial loss. For example, either where the policyholder's home is only partially damaged, or where the policyholder's vehicle was broken into, and several items were taken out of the vehicle.

In the exemplary embodiment, the PPA server 212 may store 305 a plurality of digital twins associated with a plurality of physical objects. For example, the user may have used process 100 (shown in FIG. 1) to scan the plurality of physical objects to create the plurality of digital twins. In some embodiments, the plurality of digital twins may be stored 305 in a virtual reality environment 230 (shown in FIG. 2).

In the exemplary embodiment, the PPA server 210 may receive 310 a claim from a policyholder for at least a first object of the plurality of physical objects. The PPA server 210 may receive 310 a request from the user to cover a claim. This may occur after an event has occurred and the policyholder is making a claim for lost items, such as after a fire, hurricane, tornado, or robbery.

The PPA server 210 may analyze 315 a first digital twin of the stored plurality of digital twins, where the first digital twin is associated with the first object. The first digital twin could have been created, such as through step 110 (shown in FIG. 1). The claim may be for more than just the first object, and then the steps may be repeated for each object listed in the claim.

In some embodiments, the PPA server 210 may route the first digital twin to a claims adjuster that analyzes the digital twin. In some further embodiments, where the first object is only damaged and not completely destroyed, the first digital twin is compared to one or more images of the current condition of the first object.

In the exemplary embodiment, the PPA server 210 may determine 320 a value for the first object based on the analysis. The PPA server 210 may provide 325 a replacement value or repair value for the first object to the policy holder. The replacement value may be the cost to completely replace the time. The repair value may be the cost to repair the first object back to its original value. The PPA server 325 may provide one or both of the values based on the condition of the first object.

In some embodiments, the PPA server 210 may 3-D print 330 at least a portion of the first object based on the first digital twin. In these embodiments, the PPA server 210 may generate 3-D printing files that allow a 3-D printer to print at least portions of the first object. For example, the 3-D printing files may provide replacement pieces of the first object to replace damaged pieces of the first object. The 3-D printing files may also completely rebuild the first object based on the information stored in the first digital twin.

In some embodiments, when the PPA server 210 may provide 325 the policyholder with a choice via their client computer device 205. In these embodiments, the PPA server 210 may inform the policyholder of the replacement and/or repair values. The PPA server 210 may also provide the policyholder with the option of 3-D printing either a repair or a new copy of the object based the status of the first object. If the policyholder chooses the 3-D print, then the PPA server 210 may 3-D print 330 or instruct another device, such as a 3-D printer to perform the printing.

### Exemplary Client Device

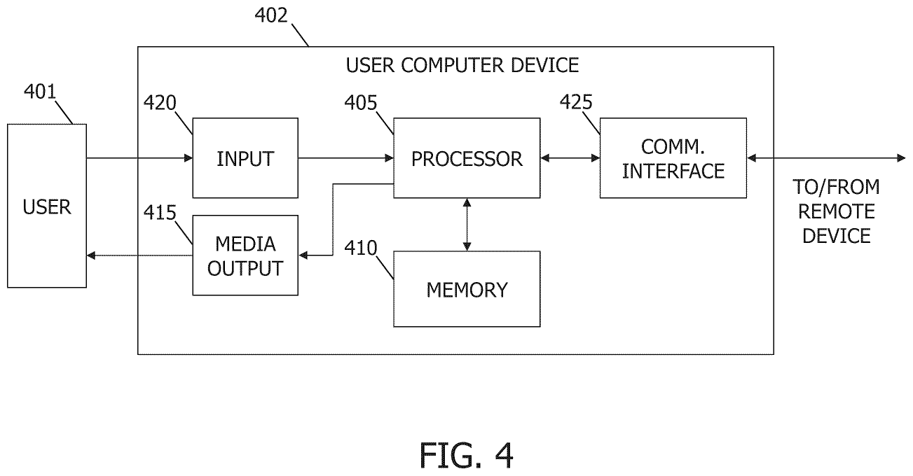

FIG. 4 depicts an exemplary configuration of a client computer device 205 shown in FIG. 2, in accordance with one embodiment of the present disclosure. User computer device 402 may be operated by a user 401. User computer device 402 may include, but is not limited to, client computer devices 205 (shown in FIG. 2). User computer device 402 may include a processor 405 for executing instructions. In some embodiments, executable instructions are stored in a memory area 410. Processor 405 may include one or more processing units (e.g., in a multi-core configuration). Memory area 410 may be any device allowing information such as executable instructions and/or transaction data to be stored and retrieved. Memory area 410 may include one or more computer readable media.

User computer device 402 may also include at least one media output component 415 for presenting information to user 401. Media output component 415 may be any component capable of conveying information to user 401. In some embodiments, media output component 415 may include an output adapter (not shown) such as a video adapter and/or an audio adapter. An output adapter may be operatively coupled to processor 405 and operatively coupleable to an output device such as a display device (e.g., a cathode ray tube (CRT), liquid crystal display (LCD), light emitting diode (LED) display, or “electronic ink” display), an audio output device (e.g., a speaker or headphones), virtual headsets (e.g., AR (Augmented Reality), VR (Virtual Reality), or XR (extended Reality) headsets).

In some embodiments, media output component 415 may be configured to present a graphical user interface (e.g., a web browser and/or a client application) to user 401. A graphical user interface may include, for example, an online store interface for viewing and/or purchasing items, and/or a wallet application for managing payment information. In some embodiments, user computer device 402 may include an input device 420 for receiving input from user 401. User 401 may use input device 420 to, without limitation, select and/or enter one or more items to purchase and/or a purchase request, or to access credential information, and/or payment information.

Input device 420 may include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both an output device of media output component 415 and input device 420.

User computer device 402 may also include a communication interface 425, communicatively coupled to a remote device such as the PPA server 210 (shown in FIG. 2). Communication interface 425 may include, for example, a wired or wireless network adapter and/or a wireless data transceiver for use with a mobile telecommunications network.

Stored in memory area 410 are, for example, computer readable instructions for providing a user interface to user 401 via media output component 415 and, optionally, receiving and processing input from input device 420. A user interface may include, among other possibilities, a web browser and/or a client application. Web browsers enable users, such as user 401, to display and interact with media and other information typically embedded on a web page or a website from the PPA server 210 and/or the virtual reality server 225. A client application allows user 401 to interact with, for example, the PPA server 210 and/or the virtual reality server 225. For example, instructions may be stored by a cloud service, and the output of the execution of the instructions sent to the media output component 415.

Processor 405 executes computer-executable instructions for implementing aspects of the disclosure. In some embodiments, the processor 405 is transformed into a special purpose microprocessor by executing computer-executable instructions or by otherwise being programmed.

### Exemplary Server Device

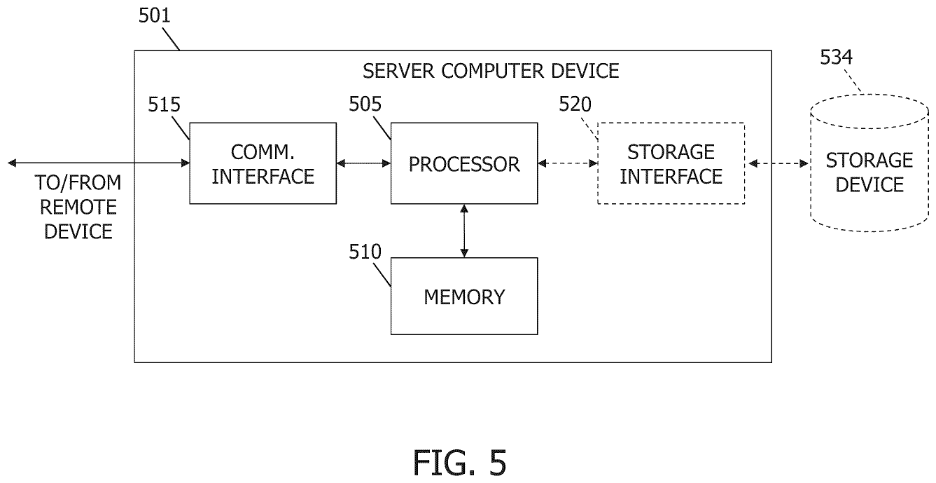

FIG. 5 depicts an exemplary configuration of a server 210 shown in FIG. 2, in accordance with one embodiment of the present disclosure. Server computer device 501 may include, but is not limited to, database server 215, PPA server 210, and virtual reality server 225 (all shown in FIG. 2). Server computer device 501 may also include a processor 505 for executing instructions. Instructions may be stored in a memory area 510. Processor 505 may include one or more processing units (e.g., in a multi-core configuration).

Processor 505 may be operatively coupled to a communication interface 515 such that server computer device 501 is capable of communicating with a remote device such as another server computer device 501, virtual reality server 225, or client computer devices 205 (shown in FIG. 2). For example, communication interface 515 may receive requests from client computer devices 205 via the Internet, as illustrated in FIG. 2.

Processor 505 may also be operatively coupled to a storage device 534. Storage device 534 may be any computer-operated hardware suitable for storing and/or retrieving data, such as, but not limited to, data associated with database 220 (shown in FIG. 2). In some embodiments, storage device 534 may be integrated in server computer device 501. For example, server computer device 501 may include one or more hard disk drives as storage device 534.

In other embodiments, storage device 534 may be external to server computer device 501 and may be accessed by a plurality of server computer devices 501. For example, storage device 534 may include a storage area network (SAN), a network attached storage (NAS) system, and/or multiple storage units such as hard disks and/or solid state disks in a redundant array of inexpensive disks (RAID) configuration.

In some embodiments, processor 505 may be operatively coupled to storage device 534 via a storage interface 520. Storage interface 520 may be any component capable of providing processor 505 with access to storage device 534. Storage interface 520 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 505 with access to storage device 534.

Processor 505 may execute computer-executable instructions for implementing aspects of the disclosure. In some embodiments, the processor 505 may be transformed into a special purpose microprocessor by executing computer-executable instructions or by otherwise being programmed. For example, the processor 505 may be programmed with the instructions such as illustrated in FIGS. 1 and 3.

### Exemplary Forever Digital Archive

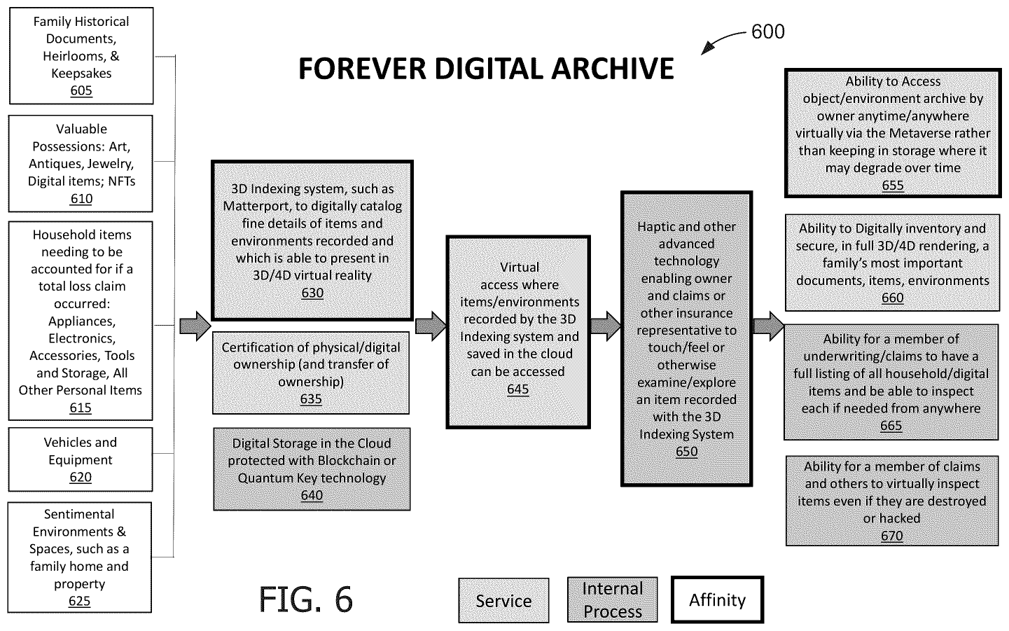

FIG. 6 illustrates a diagram of a forever digital archive 600 that may be used with the processes shown in FIGS. 1 and 3. The forever digital archive 600 collects information about a plurality of objects to archive. The objects may include, but are not limited to, Family Historical documents, Heirlooms, and Keepsakes 605. The objects to archive may also include Valuable possessions 610, such as, but not limited to, art, antiques, jewelry, and digital items, such as NFTs. The objects to archive may further include household items needing to be accounted for if a total loss claim occurs 620. These household items may include, but are not limited to, appliances, electronics, accessories, tools, storage, and all other personal items. Moreover, the objects to archive may include vehicles and other equipment 620. Additionally, the objects to archive may include sentimental environments and spaces 625, such as, but not limited to, a family home or property.

The forever digital archive 600 may use a 3-D indexing system 630, such as Matterport® (Matterport is a registered trademark of Matterport, Inc.), to digitally catalog fine details of items and environments. The items and environments are then able to be presented in 3-D/4-D virtual reality. The forever digital archive 600 may also create and provide certification 635 of physical/digital ownership and records transfer of ownership. In the exemplary embodiment, the digital storage in the Cloud may be protected 640 with blockchain or Quantum key technology.

The forever digital archive 600 may provide virtual access 645 to one or more virtual reality environments 230 provided by the insurance provider. The items and environments are recorded by a 3-D indexing system and may be saved in the cloud for future access.

The forever digital archive 600 may use haptic and other advanced technology 650 enabling the owner and representatives of the insurance provider, and potentially others allowed by the owner, to touch/feel, examine, explore, and/or otherwise interact with the items recorded in the 3-D Indexing system.

The forever digital archive 600 may provide the ability to access 655 objects and/or environments archived by the owner (or family member of the owner, an insured or policyholder, or other user). These objects and/or environment may be accessed anytime and anywhere virtually via the virtual reality environments 230 rather than keeping the physical objects in storage where they may degrade over time. The forever digital archive 600 may also provide the ability to digitally inventory and secure 660, in full 3-D/4-D rendering, a family's most important documents, items, and environments. The forever digital archive 600 may also provide the ability for a member of an insurance provider, such as a member of an underwriting team and/or a claims processing team, to have a full listing 665 of all household and/or digital items and be able to inspect each if needed from anywhere. Moreover, the forever digital archive 600 may provide the ability for a member of an insurance provider, such as a claims processor, to virtually inspect items 670 even if the items are destroyed and/or hacked.

### Exemplary Embodiments & Functionality

In one embodiment, a computer system for enhanced personal property archiving may be provided. The computer system may (i) receive a three-dimensional (3-D) scan of an object to be archived; (ii) generate a digital twin of the object based on the 3-D scan of the object; (iii) generate a non-fungible token (NFT) for the object; and/or (iv) store the NFT and the digital twin of the object. The digital twin may be stored for insurance purposes and to provide information about the object if it is ever damaged and/or destroyed. After a claim is filed, the digital twin of the object may be examined to determine a replacement and/or repair value for insurance purposes.

In some aspects, the present embodiments may relate to a computer-implemented method of enhanced personal property archiving. A 3-D scan of an object may be performed, such as by a 3-D indexer or other device. The method may include, such as via one or more local or remote processors, transceivers, and memory units, (i) receiving the three-dimensional (3-D) scan of an object to be archived; (ii) generating a digital twin of the object based on the 3-D scan of the object; (iii) generating a Non-Fungible Token (NFT) for the object; (iv) storing the NFT and the digital twin of the object; and/or (v) other actions, including those discussed elsewhere herein.

In yet another aspect, at least one non-transitory computer-readable storage media having computer-executable instructions embodied thereon may be provided. When executed by at least one processor, the computer-executable instructions cause the processor to: (1) receive a three-dimensional (3-D) scan of an object to be archived; (2) generate a digital twin of the object based on the 3-D scan of the object; (3) generate a non-fungible token (NFT) for the object; (4) store the NFT and the digital twin of the object; and/or (5) other actions, including those discussed elsewhere herein. The computer-executable instructions may direct additional, less, or alternate functionality, including that discussed elsewhere herein.

In some further enhancements, the digital twin of the object may be added to a virtual structure. The virtual structure may be a recreation of home or a business. The virtual structure includes a plurality of digital twins of a plurality of objects stored and/or placed in the virtual structure. The virtual structure and corresponding plurality of digital twins may be used allow a plurality of users to virtually conduct at least one of an event or an activity in the virtual structure. In this case, the plurality of users may interact with the plurality of digital twins. The user(s) may interact with the digital twin via a virtual reality interface, such as, but not limited to goggles and controllers. In some enhancements, the user may interact with the digital twin including a haptic response.

Furthermore, the plurality of digital objects may be used to generate an inventory of the plurality of digital twins in the virtual structure. This inventory may be used to generate an insurance policy for the physical structure that is recreated through the digital structure.

In some further enhancements, the system receives ownership information for the object associated with the 3-D scan. The ownership information may be stored in the NFT for the object. The system may also receive updated ownership information for the object and store the updated ownership information in the NFT for the object. The NFT may include a link to where the digital twin is stored.

In some enhancements, the system may generate one or more build files to 3-D print one or more portions of the object.

In some insurance-based enhancements, the digital twin of the object is provided to an underwriter to inspect for an insurance policy on the object. The digital twin of the object may also be provided to a claims processor in response to an insurance claim on the object.

The system may receive a claim from an owner of the object for an insurance policy on the object, where the object has been damaged or destroyed. The digital twin of the object may be analyzed and a value for the object may be determined based on the analysis. The system may also receive a damage report of the object (such as images of the damaged object). The damage report may be compared to the digital twin and at least one of a replacement value or a repair value for the object is determined based on the comparison and the value. In some further enhancements, the system may generate one or more build files to 3-D print one or more portions of the object to repair the object based on the comparison of the damage report to the digital twin.

In some enhancements, the object is an antique object or one of a kind object. In other enhancements, the object is a consumer product, and the system generates the digital twin from a digital twin of a previously scanned consumer product of the same make and model.

### Machine Learning & Other Matters

The computer-implemented methods discussed herein may include additional, less, or alternate actions, including those discussed elsewhere herein. The methods may be implemented via one or more local or remote processors, transceivers, and/or sensors (such as processors, transceivers, and/or sensors mounted on vehicles or mobile devices, or associated with smart infrastructure or remote servers), and/or via computer-executable instructions stored on non-transitory computer-readable media or medium.

Additionally, the computer systems discussed herein may include additional, less, or alternate functionality, including that discussed elsewhere herein. The computer systems discussed herein may include or be implemented via computer-executable instructions stored on non-transitory computer-readable media or medium.

A processor or a processing element may be trained using supervised or unsupervised machine learning, and the machine learning program may employ a neural network, which may be a convolutional neural network, a deep learning neural network, or a combined learning module or program that learns in two or more fields or areas of interest. Machine learning may involve identifying and recognizing patterns in existing data in order to facilitate making predictions for subsequent data. Models may be created based upon example inputs in order to make valid and reliable predictions for novel inputs.

Additionally or alternatively, the machine learning programs may be trained by inputting sample data sets or certain data into the programs, such as image, mobile device, vehicle telematics, and/or intelligent home telematics data. The machine learning programs may utilize deep learning algorithms that may be primarily focused on pattern recognition, and may be trained after processing multiple examples. The machine learning programs may include Bayesian program learning (BPL), voice recognition and synthesis, image or object recognition, optical character recognition, and/or natural language processing—either individually or in combination. The machine learning programs may also include natural language processing, semantic analysis, automatic reasoning, and/or machine learning.

In supervised machine learning, a processing element may be provided with example inputs and their associated outputs, and may seek to discover a general rule that maps inputs to outputs, so that when subsequent novel inputs are provided the processing element may, based upon the discovered rule, accurately predict the correct output. In unsupervised machine learning, the processing element may be required to find its own structure in unlabeled example inputs. In one embodiment, machine learning techniques may be used to extract the relevant personal belonging and/or home feature information for customers from mobile device sensors, vehicle-mounted sensors, home-mounted sensors, and/or other sensor data, vehicle or home telematics data, image data, and/or other data.

In one embodiment, a processing element may be trained by providing it with a large sample of conventional analog and/or digital, still and/or moving (i.e., video) image data, telematics data, and/or other data of belongings, household goods, durable goods, appliances, electronics, homes, etc. with known characteristics or features. Such information may include, for example, make or manufacturer and model information.

Based upon these analyses, the processing element may learn how to identify characteristics and patterns that may then be applied to analyzing sensor data, vehicle or home telematics data, image data, mobile device data, and/or other data. For example, the processing element may learn, with the customer's permission or affirmative consent, to identify the type and number of goods within the home, and/or purchasing patterns of the customer, such as by analysis of virtual receipts, customer virtual accounts with online or physical retailers, mobile device data, interconnected or smart home data, interconnected or smart vehicle data, etc. For the goods identified, a virtual inventory of personal items or personal articles may be maintained current and up-to-date. As a result, at the time of an event that damages the customer's home or goods, providing prompt and accurate service to the customer may be provided—such as accurate insurance claim handling, and prompt repair or replacement of damaged items for the customer.

### Additional Considerations

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium, such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps”, or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the term “database” may refer to either a body of data, a relational database management system (RDBMS), or to both. As used herein, a database may include any collection of data including hierarchical databases, relational databases, flat file databases, object-relational databases, object-oriented databases, and any other structured or unstructured collection of records or data that is stored in a computer system. The above examples are not intended to limit in any way the definition and/or meaning of the term database. Examples of RDBMS's include, but are not limited to, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, California; IBM is a registered trademark of International Business Machines Corporation, Armonk, New York; Microsoft is a registered trademark of Microsoft Corporation, Redmond, Washington; and Sybase is a registered trademark of Sybase, Dublin, California.)

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

In another embodiment, a computer program is provided, and the program is embodied on a computer-readable medium. In an exemplary embodiment, the system is executed on a single computer system, without requiring a connection to a server computer. In a further example embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading. Berkshire, United Kingdom). In a further embodiment, the system is run on an iOS® environment (iOS is a registered trademark of Cisco Systems, Inc. located in San Jose, CA). In yet a further embodiment, the system is run on a Mac OS® environment (Mac OS is a registered trademark of Apple Inc. located in Cupertino, CA). In still yet a further embodiment, the system is run on Android® OS (Android is a registered trademark of Google, Inc. of Mountain View, CA). In another embodiment, the system is run on Linux® OS (Linux is a registered trademark of Linus Torvalds of Boston, MA). The application is flexible and designed to run in various different environments without compromising any major functionality.

In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process may be practiced independent and separate from other components and processes described herein. Each component and process may also be used in combination with other assembly packages and processes. The present embodiments may enhance the functionality and functioning of computers and/or computer systems.

As used herein, an element or step recited in the singular and preceded by the word “a” or “an” should be understood as not excluding plural elements or steps, unless such exclusion is explicitly recited. Furthermore, references to “exemplary embodiment” or “one embodiment” of the present disclosure are not intended to be interpreted as excluding the existence of additional embodiments that also incorporate the recited features.

The patent claims at the end of this document are not intended to be construed under 35 U.S.C. § 112(f) unless traditional means-plus-function language is expressly recited, such as “means for” or “step for” language being expressly recited in the claim(s).

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A computer system for archiving into a digital environment, the computer system comprising at least one processor in communication with at least one memory device, the at least one processor programmed to:
receive a three-dimensional (3-D) scan of an object to be archived;
generate a digital twin of the object based on the 3-D scan of the object, wherein the digital twin is a 3-D representation of the object viewable at different angles and configured to be interacted with in a virtual environment;
associate supplemental data with the object, the supplemental data including (i) smart device data relating to the object retrieved from one or more smart devices located in a location where the object is present; or (ii) computer network data relating to the object retrieved from a computer network in communication with the object;
generate a non-fungible token (NFT) for the object including the supplemental data; and
store in the at least one memory device the NFT and the digital twin of the object with a link between the NFT and the digital twin.

2. The computer system of claim 1, wherein the at least one processor is further programmed to add the digital twin of the object to a virtual structure.

3. The computer system of claim 2, where the at least one processor is further programmed to add a plurality of digital twins of a plurality of objects to the virtual structure.

4. The computer system of claim 3, wherein the virtual structure recreates a home or a business and wherein the plurality of objects a located in the home or business.

5. The computer system of claim 3, wherein the at least one processor is further programmed to generate an inventory of the plurality of digital twins in the virtual structure.

6. The computer system of claim 5, wherein the at least one processor is further programmed to generate an insurance policy based on the inventory of the plurality of digital twins in the virtual structure.

7. The computer system of claim 3, wherein the at least one processor is further programmed to allow a plurality of users to virtually conduct at least one of an event or an activity in the virtual structure, wherein the plurality of users may interact with the plurality of digital twins.

8. The computer system of claim 1, wherein the at least one processor is further programmed to allow a user to interact with the digital twin via a virtual reality interface.

9. The computer system of claim 8, wherein the at least one processor is further programmed to allow a user to interact with the digital twin including a haptic response.

10. The computer system of claim 1, wherein the object is a network-connected object and the at least one processor is further programmed to:
receive ownership information for the network-connected object;
determine, via at least one of the smart device data or the computer network data, a make and/or a model of the network-connected object; and
store the ownership information in the NFT for the network-connected object, wherein the ownership information includes the make and/or the model of the network-connected object.

11. The computer system of claim 10, wherein the at least one processor is further programmed to:
receive updated ownership information for the network-connected object; and
store the updated ownership information in the NFT for the network-connected object.

12. The computer system of claim 1, wherein the NFT includes a link to where the digital twin is stored.

13. The computer system of claim 1, wherein the at least one processor is further programmed to provide the digital twin of the object to an underwriter for an insurance policy on the object.

14. The computer system of claim 1, wherein the at least one processor is further programmed to provide the digital twin of the object to a claims processor in response to an insurance claim on the object.

15. The computer system of claim 1, wherein the at least one processor is further programmed to generate one or more build files to 3-D print a complete copy of the object.

16. The computer system of claim 1, wherein the at least one processor is further programmed to:
receive a claim from an owner of the object for an insurance policy on the object, wherein the object has been damaged or destroyed;
analyze the digital twin of the object; and
determine a value for the object based on the analysis.

17. The computer system of claim 16, wherein the at least one processor is further programmed to:
receive a damage report of the object;
compare the damage report to the digital twin; and
determine at least one of a replacement value or a repair value for the object based on the comparison and the value.

18. The computer system of claim 17, wherein the at least one processor is further programmed to generate one or more build files to 3-D print one or more portions of the object to repair the object based on the comparison of the damage report to the digital twin.

19. The computer system of claim 1, wherein the object is an antique object or one of a kind object.

20. The computer system of claim 1, wherein the object is a consumer product and the at least one processor is further programmed to generate the digital twin from a digital twin of a previously scanned consumer product of the same make and model.

21. A computer-implemented method of enhanced personal property archiving, the method implemented by a computer system including at least one processor in communication with at least one memory device, the method comprises:
receiving a three-dimensional (3-D) scan of an object to be archived;
generating a digital twin of the object based on the 3-D scan of the object, wherein the digital twin is a 3-D representation of the object viewable at different angles and configured to be interacted with in a virtual environment;
associating supplemental data with the object, the supplemental data including (i) smart device data relating to the object retrieved from one or more smart devices located in a location where the object is present; or (ii) computer network data relating to the object retrieved from a computer network in communication with the object;
generating a Non-Fungible Token (NFT) for the object including the supplemental data; and
storing in the at least one memory device the NFT and the digital twin of the object with a link between the NFT and the digital twin.

22. At least one non-transitory computer-readable storage media having computer-executable instructions embodied thereon, wherein when executed by at least one processor of a computer system, the computer-executable instructions cause the processor to:
receive a three-dimensional (3-D) scan of an object to be archived;
generate a digital twin of the object based on the 3-D scan of the object, wherein the digital twin is a 3-D representation of the object viewable at different angles and configured to be interacted with in a virtual environment;
associate supplemental data with the object, the supplemental data including (i) smart device data relating to the object retrieved from one or more smart devices located in a location where the object is present; or (ii) computer network data relating to the object retrieved from a computer network in communication with the object;
generate a non-fungible token (NFT) for the object including the supplemental data; and
store in the at least one non-transitory computer-readable storage media the NFT and the digital twin of the object with a link between the NFT and the digital twin.
